(19) United States
(12) Patent Application Publication
(10) Pub. No.: US 2007/0218752 A1
(43) Pub. Date: Sep. 20, 2007

(54) Plug and Connector

(76) Inventors: Cosmo Castaldo, Westbury, NY (US); George W. Enzler, Mineola, NY (US); Patricia Roccaro, West Islip, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/683,530

(22) Filed: Mar. 8, 2007

Related U.S. Application Data
(60) Provisional application No. 60/782,930, filed on Mar. 16, 2006.

(51) Int. Cl. H01R 4/24

(52) U.S. Cl. 439/417

(57) ABSTRACT

A electrical connector includes a center portion having an end face, a first outer body portion and second outer body portion. The outer body portions are hingedly connected to the center portion. The connector also includes at least one conductor termination and preferably two conductor terminations disposed within the center portion; each of the conductor terminations are electrically coupled to a conductor at the end face of the center portion. At least one of the outer body portions has a rib positioned to urge insulated conductors into the conductor terminations when the outer body portions are closed around the center portion. The conductor terminations each have a slot for receiving the insulated conductors, with an edge effective to cut the insulation of the insulated conductor, thereby making electrical contact between the conductor and the conductor termination.

This application claims the benefit of priority pursuant to 35 U.S.C. §119(e) from a U.S. Provisional Application having Application No. 60/782,930, filed Mar. 16, 2006.

### FIELD OF THE INVENTION

This invention relates generally to plugs and connectors and more specifically to a folding plug and a connector for receiving said plug of reduced body size.

### BACKGROUND OF THE INVENTION

Plugs and connectors are devices used in industrial and home applications to provide, for example, a way to connect and disconnect one circuit from another. The plug generally has flat prongs, one end of which extends out from an insulating body and the other end of the prongs are each connected to an electrical conductor, such as a copper wire, within the insulating body. A connector typically has rectangular or arcuate openings sized to receive the prongs of a plug where each opening in the connector has a conductive member for making electrical contact with an inserted prong of a plug. As with the plug, each conductive member in the connector is connected to a conductor such as a copper wire.

An insulation displacement connector (IDC) is a wire connector which can be electrically connected to an insulated wire without first removing the insulation from the wire. Typically, with an IDC connector, the end of the prong located in the insulating body will have a wire receiving slot such as a V shaped notch. The notch is adapted to receive the end of a wire which is not stripped of insulation. As the wire is pushed into the V shaped notch, the edges of the V shaped notches cut through the insulation and make contact with the wire to provide both good mechanical and electrical connection. What is needed is a plug which is of reduced size and which can be quickly and easily connected to a conductor by a person having minimum skill.

### SUMMARY OF THE INVENTION

The present invention addresses the above-described need by providing an electrical connector including a center portion having an end face, a first outer body portion and a second outer body portion. The outer body portions are hingedly connected to the center portion. The connector also includes at least one insulation displacement conductor termination and preferably at least two insulation displacement conductor terminations disposed within the center portion; each of the conductor terminations are electrically coupled to a conductor at the end face of the center portion. At least one of the first outer body portion and the second outer body portion has at least one rib, positioned to urge insulated conductors into the respective conductor terminations when the first outer body portion and the second outer body portion are closed around the center portion. In an embodiment, the conductor terminations each have a slot for receiving the insulated conductors, with an edge effective to cut the insulation of the insulated conductor, thereby making electrical contact between the conductor and the conductor termination.

The end face of the center portion of the connector may have one or more conducting prongs and preferably two or more conducting prongs extending therefrom, thereby forming a plug.

In an embodiment, the first outer body portion and the second outer body portion each has a curved outer surface, so that the first outer body portion and the second outer body portion when coupled together form a substantially cylindrical body, and the end face of the center portion forms an end face of the cylindrical body. It should be noted, however, that the body can be rectangular, oval, or any other desired shape without departing from the spirit of the invention.

The foregoing has outlined, rather broadly, the preferred features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1A is a side view of a plug and connector in accordance with an embodiment of the invention.

FIG. 1B is a perspective view of the plug and connector of FIG. 1A.

FIG. 2A is a perspective view of the plug of FIG. 1A when open.

FIG. 2B is a perspective of the plug partially closed with a wire positioned in the plug.

FIG. 3 shows the wire capture feature of a conductor termination, in accordance with an embodiment of the invention.

### DETAILED DESCRIPTION OF PREFERRED EMBODIMENTS

In an embodiment of the invention, a plug has a locking type body and Insulation Displacement Connector (IDC) terminations that incorporate a wire capture feature which helps to hold, capture and position electrical conductors. The plug has two side members connected to a center member with live hinges. The side members are protected from separation from the center member by special interlocks at the hinge line to positively lock the side members into place and prevent plug body separation or pull-out, even if the hinges are completely severed. As the side members are brought together and closed about the center member, ribs in the plug body guide a properly positioned insulated conductor into slots or grooves in the IDC terminals to make good electrical contact between the conductor and the prong and help prevent the conductors from backing out of the plug.

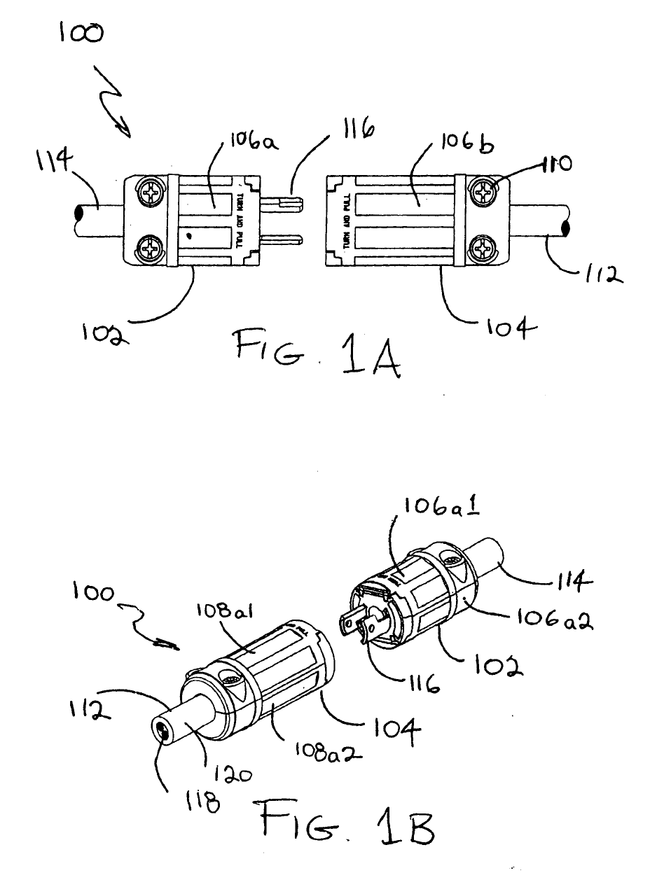

FIGS. 1A and 1B show an implementation of an Insulation Displacement Connector (IDC) assembly 100 consisting of a plug 102 and a connector 104. Prongs 116 of the plug are configured to mate with conductive members in the connector. The outer body 106a of the plug and 106b of the connector each can be configured as half sections 106a1, 106a2 and 108a1, 108a2, which when coupled together, for example, by one or more screws 110, form two cylindrical bodies (although the bodies may have any suitable shape). The plug and the connector are each connected to a wire having at least two insulated conductors. Alternatively, the plug and connector may be connected to a wire with only a single conductor.

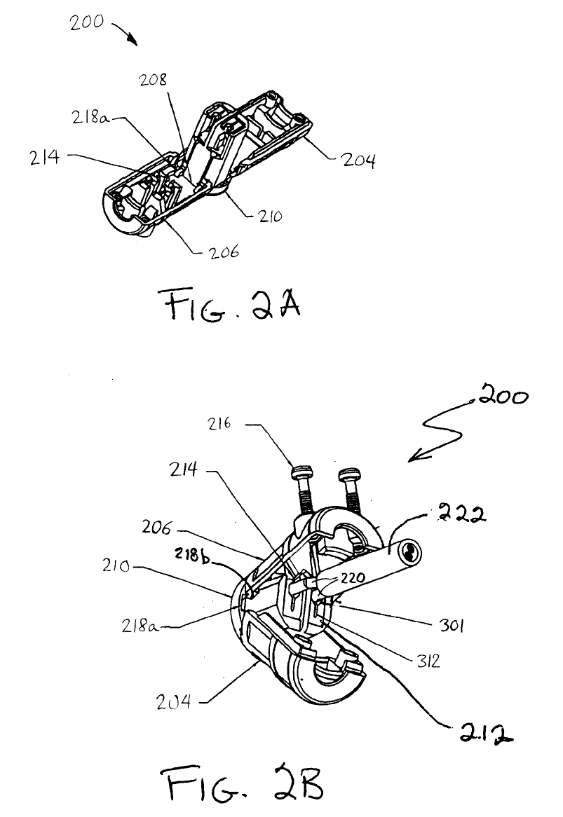

Referring to FIGS. 2A and 2B, there is shown a connector 200 having a two piece outer body including right-side and left-side members 204, 206 where each side member is one-half of a cylinder and each cylinder half is connected with a live hinge 208 to a center member 210. The center member includes conductor terminations 212 which are adapted to engage and make electrical contact with insulated conductors 220 of a wire 222. The conductor terminations 212 are composed of a conductive material such as brass, etc., and can be the ends of the prongs 116 in the plug or the ends of conductive members in the connector. Each conductor termination 212 has an split key hole slot 301 for receiving an insulated wire conductor 220. A rib set 214 which projects from the inside surface of a side member is located opposite the conductor terminations 220 and positioned to press the conductors 220 into the split key hole slots 301 of the conductor terminations 212 as the side members are closed about the center member 210. The rib set prevents the wires from bulging out and also guides and urges the wires into the split key hole slots as the side members are brought together. Screws 216 are used to hold the side members 204, 206 together around center member 210. Center member 210 includes interlock slot 218a that accepts and engages with mating interlock protrusion or rib 218b on the inside surface of each side member 204, 206 when the side members are closed about the center member 210. When interlock slot 218a engages interlock rib 218b, the side members are prevented from spreading out, even when both hinges are completely broken.

An input wire cable 222 can include two conductors 220, each of which can be positioned in the split keyhole slots 301 of conductor terminations 212 coupled to the center member 210 of the connector 200. To close the plug, the side members 204, 206 are pivoted about the hinges 208. As the side members close about the center member, the rib set 214 guides and urges each conductor 220 into a respective split keyhole slot in the conductor terminations 212. As the conductors are urged into the tapered wire capture slots 312 of the split keyhole slots, the insulation on each conductor is cut by the edges of the split keyhole slots and the conductor terminations 212 make electrical contact with the conductors 220. The rib set 214 also prevents the conductors from bulging out of the conductor terminations. When the side members are fully closed about the center member, the interlock protrusions of ribs 218b are mated with the interlock slot 218a of the center member 210. Screws 216 or other securing mechanism can be used to hold the side members 204, 206 together and around center member 210.

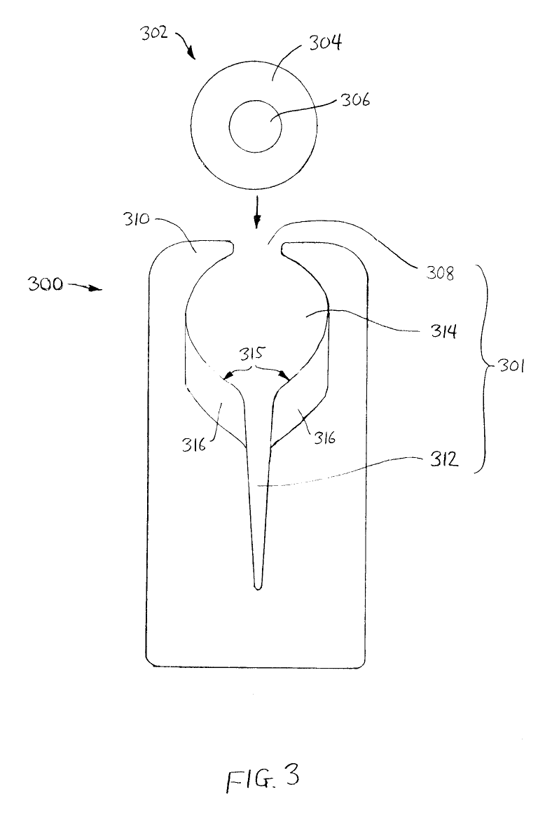

Referring to FIG. 3, there is shown a conductor termination 300 having a split keyhole slot 301 which makes electrical contact with an insulated conductor by cutting through the insulation on the wire. The edge regions 316 adjacent the split keyhole slot can formed to provide sharpened edges 315 to enhance insulation displacement. In operation, a wire 302 having a conductor 306 encased in insulation 304 is urged into the split keyhole slot 301 in the conductor termination 300. Tines 310 on each side of the split keyhole slot spread apart to accommodate the wire 302 as the wire is pressed into the split keyhole slot. The tines 310 close about the wire 302 as the wire moves through passageway 308 to capture the wire in the wire receiving opening 314 of the split keyhole slot. As the wire is further urged into the tapered wire capture slot 312, the insulation 304 is cut or displaced by the edges 315 of the keyhole slot, thereby exposing the conductor 306 and making a mechanical and electrical connection between the conductor 306 and the conductor termination 300. Although the conductor termination 300 is shown as having a split keyhole slot, it should be noted that any suitable construction of the termination may be used provided that the conductor is adequately captured.

While the invention has been described in terms of specific embodiments, it is evident in view of the foregoing description that numerous alternatives, modifications and variations will be apparent to those skilled in the art. Accordingly, the invention is intended to encompass all such alternatives, modifications and variations which fall within the scope and spirit of the invention and the following claims.

1. An electrical connector comprising:
a center portion including an end face;
a first outer body portion hingedly connected to the center portion;
a second outer body portion hingedly connected to the center portion;
at least two conductor insulation displacement terminations disposed within the center portion, each of the conductor terminations being electrically coupled to a conductor at the end face of the center portion,
at least one rib in at least one of the first outer body portion and the second outer body portion, positioned to urge insulated conductors into respective conductor terminations when the first outer body portion and the second outer body portion are closed around the center portion.

2. An electrical connector according to claim 1, wherein the conductor terminations each have a slot for receiving the insulated conductors.

3. An electrical connector according to claim 2, wherein the slot in each conductor termination has an edge effective to cut the insulation of the insulated conductor, thereby making electrical contact between said conductor and the conductor termination.

4. An electrical connector according to claim 1, wherein the first outer body portion and the second outer body portion each have a curved outer surface, so that the first outer body portion and the second outer body portion when coupled together form a substantially cylindrical body, said end face of the center portion forming an end face of the cylindrical body.

5. An electrical connector according to claim 1, wherein the rib projects from an inside surface of said outer body portion.

6. An electrical connector according to claim 1, wherein each of the first outer body portion and the second outer body portion further includes an interlock rib disposed on the inside surface thereof, and the center portion has slots formed therein for engaging with said interlock ribs when the first outer body portion and the second outer body portion are closed around the center portion.

7. An electrical connector according to claim 6, wherein engagement of said slots with said interlock ribs is effective to prevent relative movement of the first outer body portion and the second outer body portion in the event of loss of hinge connection with the center portion.

8. An electrical connector according to claim 2, wherein said slot of each conductor termination includes a tapered portion for capturing a conductor, thereby making a mechanical and electrical connection between said conductor and the conductor termination.

9. An electrical connector according to claim 2, wherein each slot includes
an opening at one end of the conductor termination, forming a passageway for an insulated conductor,
a wire receiving opening, opening to the passageway; and
a tapered portion, opening to said wire receiving opening and opposite said passageway.

10. An electrical connector according to claim 2, wherein said conductor termination is configured to spread apart with respect to said slot to accommodate an insulated conductor urged into said slot

11. An electrical plug comprising:
a center portion including an end face;
a first outer body portion hingedly connected to the center portion;
a second outer body portion hingedly connected to the center portion;
at least two conductor insulation displacement terminations disposed within the center portion, each of the conductor terminations being electrically coupled to a conductor at the end face of the center portion,
at least one rib in at least one of the first outer body portion and the second outer body portion, positioned to urge insulated conductors into respective conductor terminations when the first outer body portion and the second outer body portion are closed around the center portion.

12. An electrical plug according to claim 11, wherein the conductor terminations each have a slot for receiving the insulated conductors.

13. An electrical plug according to claim 11, wherein the first outer body portion and the second outer body portion each have a curved outer surface, so that the first outer body portion and the second outer body portion when coupled together form a substantially cylindrical body, said end face of the center portion forming an end face of the cylindrical body.

14. An electrical plug according to claim 11, wherein the rib projects from an inside surface of said outer body portion.

15. An electrical plug according to claim 11, wherein each of the first outer body portion and the second outer body portion further includes an interlock rib disposed on the inside surface thereof, and the center portion has slots formed therein for engaging with said interlock ribs when the first outer body portion and the second outer body portion are closed around the center portion.

16. An electrical plug according to claim 15, wherein engagement of said slots with said interlock ribs is effective to prevent relative movement of the first outer body portion and the second outer body portion in the event of loss of hinge connection with the center portion.

17. An electrical plug according to claim 12, wherein said slot of each conductor termination includes a tapered portion for capturing a conductor, thereby making a mechanical and electrical connection between said conductor and the conductor termination.

18. An electrical plug according to claim 12, wherein each slot includes
an opening at one end of the conductor termination, forming a passageway for an insulated conductor,
a wire receiving opening, opening to the passageway; and
a tapered portion, opening to said wire receiving opening and opposite said passageway.
